(19) United States
(12) Patent Application Publication
(10) Pub. No.: US 2013/0246171 A1
(43) Pub. Date: Sep. 19, 2013

(54) Fuel Dispensing Environment Utilizing Mobile Payment

(71) Applicant: Giovanni Carapelli, High Point, NC (US)

(72) Inventor: Giovanni Carapelli, High Point, NC (US)

(21) Appl. No.: 13/612,472

(22) Filed: Sep. 12, 2012

Related U.S. Application Data
(60) Provisional application No. 61/534,212, filed on Sep. 13, 2011.
(60) Provisional application No. 61/541,360, filed on Sep. 30, 2011.

(51) Int. Cl. G06Q 20/32; G06Q 50/06

(52) U.S. Cl. CPC G06Q 20/3278; G06Q 50/06
USPC 705/14.51; 705/44

(57) ABSTRACT

A mobile payment system for effecting payment for a contemporaneous transaction comprises a payment terminal having a proximity reader configured to detect an identifier associated with a wireless communication device. A central server is in operative communication with the payment terminal and the wireless communication device. At least one database, accessible by the central server, contains an association between the identifier and the wireless communication device. The central server is further operative to send transaction information to the wireless communication device.

### PRIORITY CLAIM

This application is based upon and claims the benefit of U.S. provisional application Ser. No. 61/534,212, filed Sep. 13, 2011 and U.S. provisional application Ser. No. 61/541,360, filed Sep. 30, 2011, both of which are incorporated fully herein by reference.

### FIELD OF THE INVENTION

The present invention relates generally to service stations at which fuel is dispensed. More particularly, the present invention relates to use of a mobile phone or other portable mobile device to effect payment for a service station or other retail transaction.

### BACKGROUND

Transaction processing within a retail fueling environment conventionally includes interaction between a customer and a fuel dispenser. The customer typically presses certain keys on a user interface provided on the fuel dispenser to provide input for a transaction. Output is provided to the customer in response by the user interface (typically via a visual display). The customer obtains payment authorization for the transaction by swiping a credit card at the fuel dispenser (also referred to as “pay at the pump”) or communicating with an attendant situated at a point of sale (POS) terminal. After authorization is received, the customer dispenses fuel and interacts with the user interface of the fuel dispenser to complete the transaction. An example of such a fuel dispenser interface is the card reader in dispenser (CRIND®) equipped fuel dispenser manufactured by Gilbarco Inc.

There have been efforts to effect payment for various goods and services via mobile devices such as cell phones. Because initial technology was based on proprietary messaging through cell phone networks, “payment roaming” was not possible. Alternative techniques, like that described in U.S. Pub. App. No. 2004/0050648 (incorporated herein by reference for all purposes), describe Internet-based payment using a mobile phone able to connect to the internet and a vending machine (“VM”) also connected to the internet. In this regard, at least one action is first taken by the customer to identify the vending machine. For example, the '648 application discloses the concept of a “unique VM identification number,” which the customer keys in on the phone. A central server, connected to both the phone and the VM, acts as clearinghouse and establishes a “virtual connection” between the phone and the VM.

With such a system, the VM identification number needs to be visible on the VM, either in the form of a physical placard or an image dynamically displayed on a digital display that is integrated on the VM. In the latter case, the code can be changed for each transaction, thus providing a unique coupling between customer and device to make the transaction more secure. An alternative way to transfer the VM identification number to a phone is via a bar code (such as a QR code) that also could be dynamically generated and rendered on the VM's display. The bar code would be imaged via a camera integrated into the customer's phone.

Both the manual input of a numeric code and the QR snapshot have certain limitations. In the first case, the number must be short enough to make a manual input reasonable, but this tends to reduce security and number of devices on the network. In the case of QR code with photo camera, the lighting conditions and the actual visibility of the QR code might make an effective, reliable application problematic.

Another alternative concept that has been introduced in the last few years is known as NFC (Near Field Communication). NFC allows a proximity bidirectional communication between a cell phone (integrating a special NFC chip) and the VM having a suitable NFC reader. At this point, however, infrastructure necessary for widespread use of NFC is not in place. Another limitation of NFC is “functional”—to work, NFC requires the phone to be in proximity, i.e. a few centimeters at most, to the reader at all times. This condition is acceptable for a simple identification but is problematic for transactions requiring a longer interaction.

### SUMMARY

The present invention recognizes and addresses the foregoing considerations, and others, of prior art construction and methods. In this regard, certain exemplary and nonlimiting aspects of the present invention will now be described. These aspects are intended to provide some context for certain principles associated with the present invention, but are not intended to be defining of the full scope of the present invention.

Certain aspects of the present invention are directed to a system for effecting transaction payment at a fuel dispenser, vending machine or other payment terminal. Examples of retail fueling environments, fuel dispensers, and user interfaces for fuel dispensers are provided in U.S. Pat. No. 6,453,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), U.S. Pat. No. 6,935,191 (entitled “Fuel Dispenser Fuel Flow Meter Device, System and Method”), U.S. Pat. No. 7,289,877 (entitled “Fuel Dispensing System for Cash Customers”) and U.S. Pat. No. 7,774,231 (entitled “Electronic Payment Methods for a Mobile Device”) and U.S. published patent application nos. 20090048710 (entitled “Fuel Dispenser”), 20100268612 (entitled “Payment Processing System for Use in a Retail Environment Having Segmented Architecture”), and 20110185319 (entitled “Virtual PIN Pad for Fuel Payment Systems”). The entire disclosure of each of the foregoing patents and applications is hereby incorporated by reference as if set forth verbatim herein for all purposes.

According to one aspect, the present invention provides a system in which a proximity connection is used to identify a customer's cell phone or other mobile device in order to initiate payment. In this regard, a suitable proximity indicator such as an RFID tag may be attached to the phone (such as in the form of a sticker) or otherwise carried by the customer. For example, depending on the particular model of phone, a special “case” could be sold with the RFID embedded inside the case itself. Alternatively, NFC communication may be utilized between the phone and the payment terminal (e.g., fuel dispenser). In many embodiments, a specialized software application (i.e., an “app”) is pre-installed on the phone and can be run on the phone's internal processor. The app is preferably launched (i.e., initiated) by a “push” from the cell phone network (or wi-fi) and provides an interface on the phone for the transaction. For example, the interface may allow the customer to select a payment option (e.g., a particular credit card) from among a group of alternatives and then show a running total of the transaction (volume and monetary) after it is approved. Coupons or other promotional messages may be sent to the phone over the network for subsequent use by the customer. While the app will generally be a special purpose app, it may, in some embodiments, be the mobile device's web browser which is launched and directed to a specific website by the push message. The functionality could be performed at the website and displayed on the phone via the web browser.

To enable the new payment service, a customer activates the combination of phone (with the payment app installed) and the proximity indicator (e.g., RFID tag). This activation may preferably be performed in a location where a special RFID reader is installed and connected to an activation computer, also connected to the internet (or other suitable computer network). During the activation, the phone and the proximity indicator are “virtually” paired (preferably in a remote, secure database). The customer may also select the default method of payment that will be “virtually” linked to that phone/RFID couple.

Once the “activation” is completed, the customer can initiate a payment sequence at any fuel dispenser (or other payment terminal) enabled with the requisite payment service. For example, the enabled fuel dispenser or other payment terminal may preferably be equipped with a proximity reader (such as an RFID reader also compatible with NFC) and connected to a suitable computer network such as the internet. The back-end infrastructure utilizes a central server also connected to a suitable computer network such as the internet. Each payment terminal reports to the server its status in real time and establishes a secure connection before becoming operational (i.e., ready for selling).

The following is an exemplary sequence of a payment experience (from the customer's standpoint) in accordance with some embodiments of the present invention:

First, the customer activates the payment app in the phone (the app could be activated only once and kept active in background, enable to “push messages”). The app is connected to the “payment network” via digital network (UMTS, GPRS etc.) or NFC communication channel. When active, the app checks periodically for payment requests pending on the central server. In the case of NFC, the payment terminal (dispenser) electronics can use the NFC channel (or other short-range or direct communication with the payment terminal) as a data transport to a remote host such as the central server noted above. In any event, the communication can be encrypted as desired, with mutual authentication (PKI) or other typical secure identification techniques.

Next, the customer approaches the payment terminal, and places the phone in proximity of the proximity reader installed on the payment terminal (which is normally clearly identified with a label).

Next, the payment terminal reads the customer's identification code (ID) from the RFID tag integrated in the phone (or NFC memory). The ID may be transmitted via internet to the central server, together with the terminal's identification information (number, address, retailer, etc).

Next, the central server checks the mailbox for the requested customer ID (to check if the ID is valid); if yes, a message is posted requesting to activate a payment transaction for the calling payment terminal.

Next, the phone, which is periodically checking the payment request via the installed app, receives the message via the digital network (or NFC) and immediately displays the request to the customer. For example, the phone may show the payment terminal identification data and prompt the customer to confirm the payment transaction with a personal identification number (PIN) code. In embodiments where communications are now occurring over the digital network, there is no longer a need to hold the phone in close proximity to the payment terminal during this transaction. As will be explained below, the “virtual channel” established between phone and payment terminal allows the phone to advantageously display other information, such as transaction data.

After being prompted, the customer enters the PIN on the cell phone. The app sends the PIN to the central server. Payment terminal identification information may also be sent to the central server. If everything is valid, the central server instructs the payment terminal to authorize the sale.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a system for effecting payment in a fueling environment in accordance with an embodiment of the present invention;

FIG. 2 is a flow chart showing exemplary process steps occurring at a mobile phone in accordance with an embodiment of the present invention;

FIG. 3 is a flow chart showing exemplary process steps occurring at a fuel dispenser payment terminal in accordance with an embodiment of the present invention;

FIG. 4 is a flow chart showing exemplary process steps occurring at a central server in accordance with an embodiment of the present invention;

FIG. 5 is a diagrammatic representation of a fuel dispenser interface and a cell phone adjacent a proximity reader thereof to effect a payment transaction in accordance with an embodiment of the present invention.

FIG. 6 is a view similar to FIG. 5 but showing the cell phone moved away from the proximity reader after initial identification has occurred.

FIG. 7 is a view similar to FIG. 5 showing transfer of a coupon to the cell phone via the proximity reader, it being understood that many embodiments of the present invention will preferably use the cell phone network or wi-fi for this purpose.

FIG. 8 is a view similar to FIG. 5 showing transfer of a receipt to the cell phone via the cell phone digital network.

FIG. 9 is a view similar to FIG. 5 showing transfer of the receipt to the cell phone via the proximity reader.

FIG. 10 shows a display on the cell phone listing stored coupons and promotional messages.

FIG. 11 shows promotional messages that may be displayed on the cell phone based on the customer's location.

FIG. 12 is an exemplary home interface for the app installed on the cell phone, showing buttons to access stored coupons and stored receipts.

FIG. 13 is an exemplary page displayed by the app installed on the cell phone indicating that fueling may begin.

FIG. 14 is an exemplary page displayed by the app installed on the cell phone showing the running transaction total.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

As noted above, aspects of the present invention preferably utilize a proximity reader located at (near) the fuel dispenser or other payment terminal to initiate a payment transaction. Detection of the mobile device (such as via NFC or an RFID tag) preferably causes a “push message” to be sent to the mobile device via the phone network. This push message can launch an installed app which serves as an interface for the transaction. Payment can occur via the default credit card corresponding to the mobile device-proximity indicator couple, or the form of payment (i.e., particular credit card) may be selected by the customer via the app. The customer's loyalty account may be credited automatically, and promotional messages or coupons may be sent to the mobile device. The coupons can be stored on the mobile device for later use by the customer.

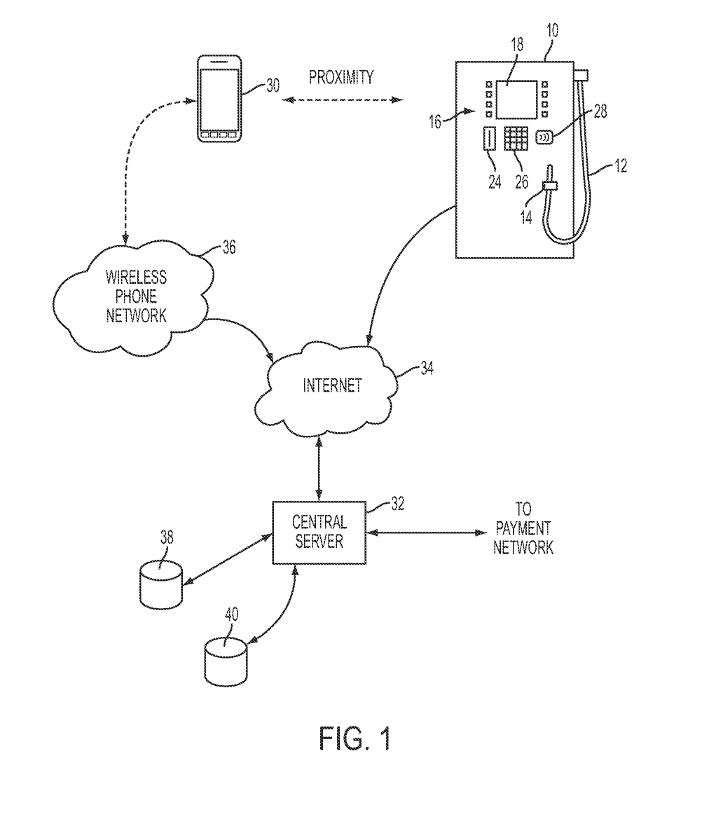

Referring now to FIG. 1, a payment system in accordance with an embodiment of the present invention is illustrated. In this embodiment, the payment terminal is incorporated into a fuel dispenser 10 located in a retail fueling environment. One skilled in the art will appreciate that such a retail fueling environment will typically include multiple fuel dispensers located in the forecourt adjacent a “central” building which may house a convenience store and/or a quick serve restaurant (QSR). The plurality of fuel dispensers in the retail fueling environment typically communicate with and are controlled by a site controller, such as a suitable point-of-sale (POS) system, located in the central building.

As one skilled in the art will appreciate, fuel dispenser 10 includes various electronic and hydraulic components used to perform a fueling transaction. In this regard, fuel dispenser 10 typically includes internal piping that interconnect fuel dispenser 10 to underground piping at the fueling site. The underground piping is itself connected to one or more underground storage tanks in which bulk quantities of fuel are stored. One or more valves located in the fuel dispenser are opened when the fueling transaction is authorized in order to dispense the fuel. A flow meter records the quantity of fuel passing into the customer's vehicle through hose 12 and nozzle 14.

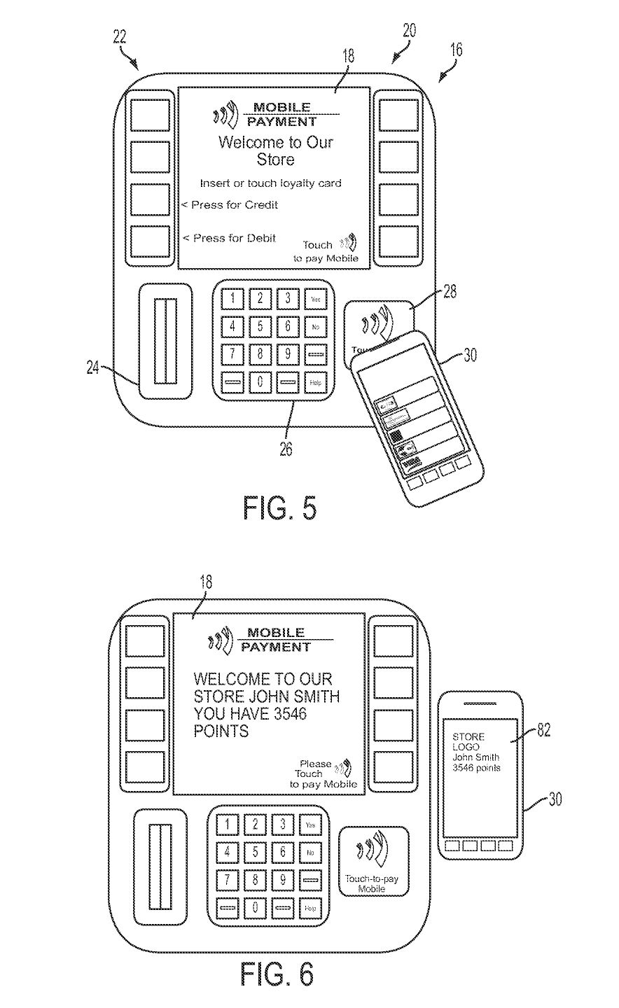

Fuel dispenser 10 includes a user interface 16 by which the customer may interact with the fuel dispenser. Referring now to FIG. 5, interface 16 in this case includes a suitable display 18 (such as an LCD color display) beside which are located a series of “soft keys” 20 and 22. As one skilled in the art will appreciate, the soft keys allow selections to be made for corresponding choices given on display 18. For example, two of the soft keys are being used in FIG. 5 to allow selection of “credit” or “debit.” Alternatively, display 18 may be a touch screen in which user selections are made directly on the screen.

User interface 16 further includes a card reader 24 which may be configured to read a typical magnetic stripe wallet card, a smart card, or other type of wallet card as necessary or desired. A numeric “PIN” pad 26 is also provided at user interface 16. As one skilled in the art will appreciate, PIN pad 26 permits the customer to enter a personal identification number (PIN), a postal code, or some other identifier that can be used to enhance the security of a transaction. User interface 16 further includes a proximity reader 28, which is in this embodiment configured as an RFID reader also compatible with NFC. A fuel dispenser having an RFID reader is disclosed in U.S. Pat. No. 6,089,284, incorporated herein by reference in its entirety for all purposes.

As will be explained, the customer's cell phone 30 (or other mobile device) is preferably equipped with a proximity indicator such as an RFID tag. For example, such an RFID tag may be in the form of a sticker attached to the back of the cell phone, or may be embedded in the cell phone housing or a separate case (i.e., a “skin”). In any event, the mobile device is brought into proximity with the proximity reader 28 in order to initiate a transaction, as shown in FIG. 5. Alternatively, an associated RFID tag may be simply carried by the customer (e.g., key chain fob) but this will generally be considered to be less convenient.

Typically, cell phone 30 may be a “smart phone” capable of running multiple and/or downloadable apps, such as those sold by Apple, Motorola, Samsung, HTC and others. Moreover, while a cell phone is one example of a wireless communication (mobile) device that may be used with embodiments of the present invention, other types of mobile devices may also be used for this purpose. For example, certain embodiments of the present invention may utilize various tablet computers.

Referring again to FIG. 1, fuel dispenser 10 and cell phone 30 communicate with a central server 32 via a suitable computer network such as the internet (indicated at 34). In this regard, the fuel dispenser may be connected to the internet (or other suitable computer network) via a “secure connection,” which may be direct or indirect (such as through a site server, point of sale (POS) system, or any other internet access device at the retail site). The dispenser is able to authenticate itself to central server 32 which monitors the status of the dispenser and monitors requests from a user's mobile device. As shown, however, the internet connection of phone 30 typically occurs wirelessly over the digital phone network in this case, as indicated at 36. Alternatively, phone 30 may access the internet via a local wifi connection.

Central server 32 is in communication with one or more databases, such as databases 38 and 40. For example, database 38 may contain information regarding fuel dispensers or other payment terminals that are available for transactions. Typically, each such dispenser will have a unique ID by which it is identified and distinguished from others. Database 40 may contain the association between a customer ID embedded in an RFID tag and a particular cell phone (or other mobile device). Other information, such as a default method of payment for the mobile device-proximity indicator couple, may also be stored in database 40. Central server 32 further communicates with a payment network as necessary to effect payment for the transaction.

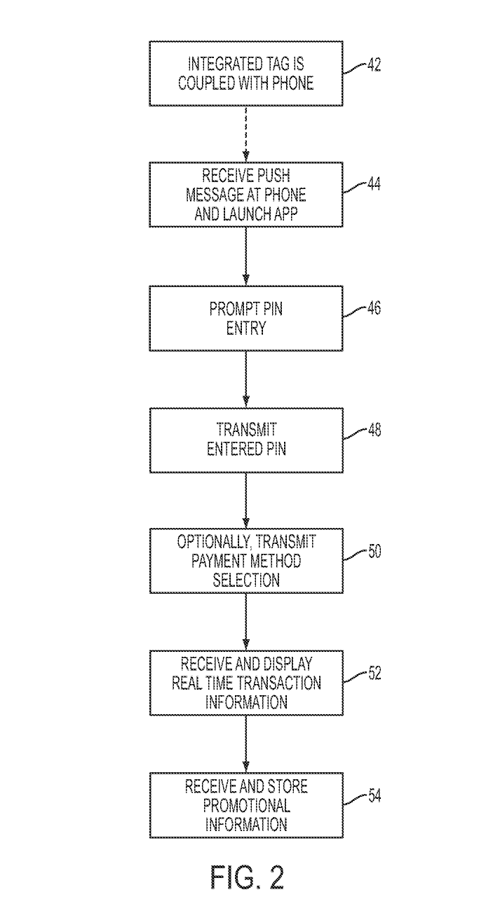

FIGS. 2 through 5 illustrate exemplary methodology that may occur in accordance with an embodiment of the present invention at phone 30, fuel dispenser 10 and central server 32, respectively. Referring first to FIG. 2, the integrated tag (proximity indicator) is previously associated (or “coupled”) to a particular phone 30 via an enrollment process (as shown at 42). The result is stored in database 40 for later use. (The discontinuity in the flow chart indicates that this step does not usually occur at the same time as a transaction.)

As noted above, a customer brings phone 30 into proximity with reader 28 at the beginning of a transaction. If the couple is validated, a push message is received at the phone 30 (as indicated at step 44) causing the payment app installed on the phone to be launched. Preferably, as indicated at 46, the customer may be prompted by the app to enter a PIN code into the phone. The PIN code is then transmitted to the central server for confirmation, as indicated at 48. Next, the app may prompt the user to select a desired method of payment (as indicated at 50), unless the system is configured to use only a default method of payment stored in the database. The cell phone app may display real time transaction information as the transaction is in progress (as indicated at 52). For example, the phone may show the monetary and/or volume total on a real-time basis as fuel is being dispensed. Either during, or before the transaction is finally concluded, coupons or promotional messages may be received at the phone 30 (as indicated at 54).

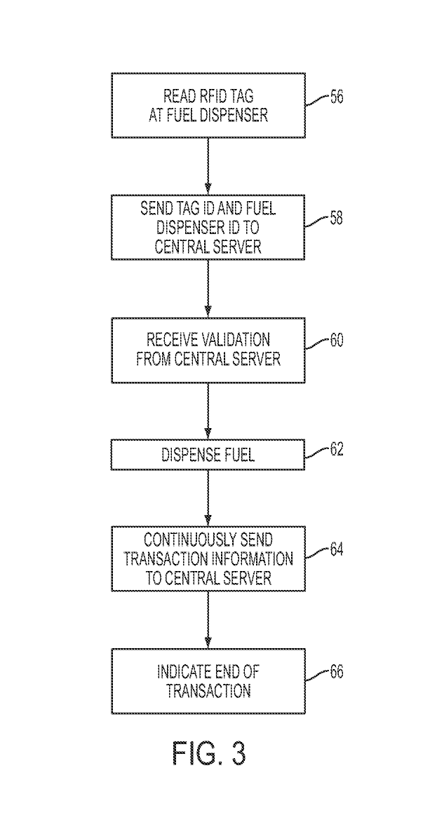

Referring now to FIG. 3, steps that may occur at the fuel dispenser or other payment terminal will now be described. As indicated at 56, the RFID tag (or other proximity indicator) associated with phone 30 is detected at reader 28. The customer ID transmitted to reader 28 by the tag is then sent, along with a terminal ID (and potentially other information indicative of the retail site), to central server 32 (as indicated at 58). If the fuel dispenser receives validation (i.e., authorization to dispense fuel) from the central server (as indicated at 60), fuel is allowed to be dispensed by the customer (as indicated at 62). During the transaction, the fuel dispenser preferably sends transaction information (i.e., volume and monetary total) to central server 32 on a continuous basis (as indicated at 64). Once the transaction is complete, an indication thereof is sent to central server 32 (as indicated at 66) so that the customer's payment method can be charged for the correct total.

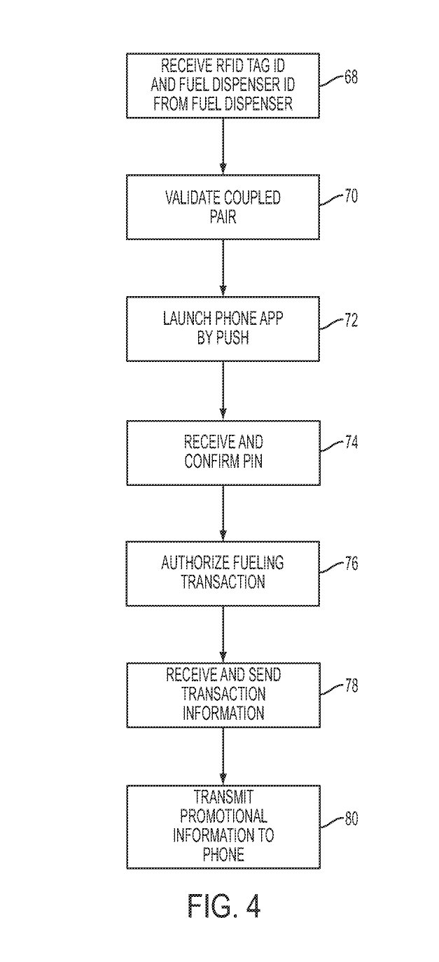

FIG. 4 shows method steps that may occur at the central server 32. As indicated at 68, the tag ID and fuel dispenser ID are received from fuel dispenser 10 after the user has brought phone 30 into position near reader 28. Based on information in database 40, central server 32 then determines whether the tag ID is valid and, if so, what mobile device corresponds to that tag ID (as indicated at 70). Based on the association thus determined, central server 32 sends a “push” message out to phone 30 which causes the payment app on the phone to be launched (as indicated at 72). As noted above, the app may prompt the user to enter a PIN, which is received at central server 32 and confirmed if valid (as indicated at 74). The fueling transaction is then authorized based on the customer's selected method of payment (or default payment method), as indicated at 76. Because the dispenser and the phone 30 can “see each other,” transaction information received from the fuel dispenser during the fueling transaction may be forwarded to phone 30 as the transaction progresses (as indicated at 78). Either during or before final conclusion of the transaction, coupons and various other promotional messages may be sent to phone 30 (as indicated at 80).

Various aspects of the present invention may be further explained with reference to FIGS. 5-14. In this regard, FIG. 5 illustrates an example screen shown on phone 30 whereby the user may select from several payment alternatives (e.g., AMEX, Visa, MasterCard, fuel company card, etc.). In FIG. 6, the customer has been identified and certain relevant information, such as a personal greeting to the customer, is being displayed. Here, such information (e.g., the customer's name and loyalty point total) is being shown on both the fuel dispenser's display 18 and the display 82 of phone 30. In some embodiments, it may be desirable to show such messages only on phone 30 for privacy reasons (or in cases where the fuel dispenser is not equipped with its own display). In the case of most modern smart phones, display 82 may be a touch screen display.

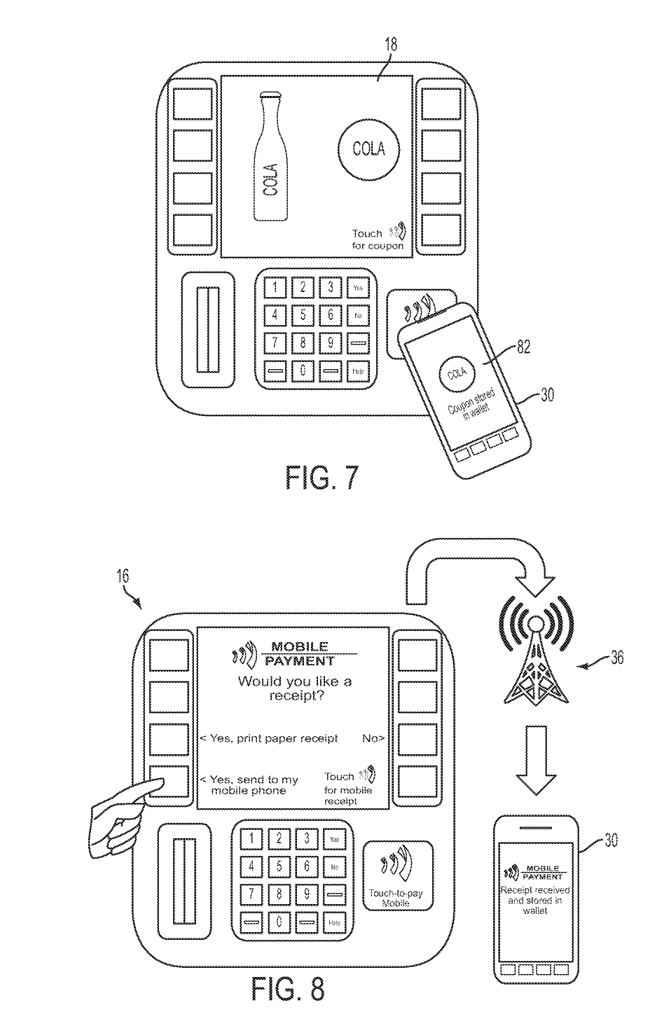

In FIG. 7, the customer is being shown a promotional message indicating that a coupon is available for transfer to phone 30. Such messages may be advantageously provided during the time that the fueling transaction is in progress. Any such coupons may be stored in phone 30 for use in the convenience store of the retail fueling environment or at third party retail locations (depending on the specifics of the coupon). In this example, phone 30 is equipped with NFC, allowing transfer of the coupon directly to the phone (by moving the phone close to reader 28 during the transaction). In other embodiments, however, it will be more desirable to provide the coupon(s) via the digital phone network 36. This obviates the need to move the phone into proximity with the reader in order to receive the coupon. The prompt asking the customer whether the coupon is desired can be generated by the phone's payment app.

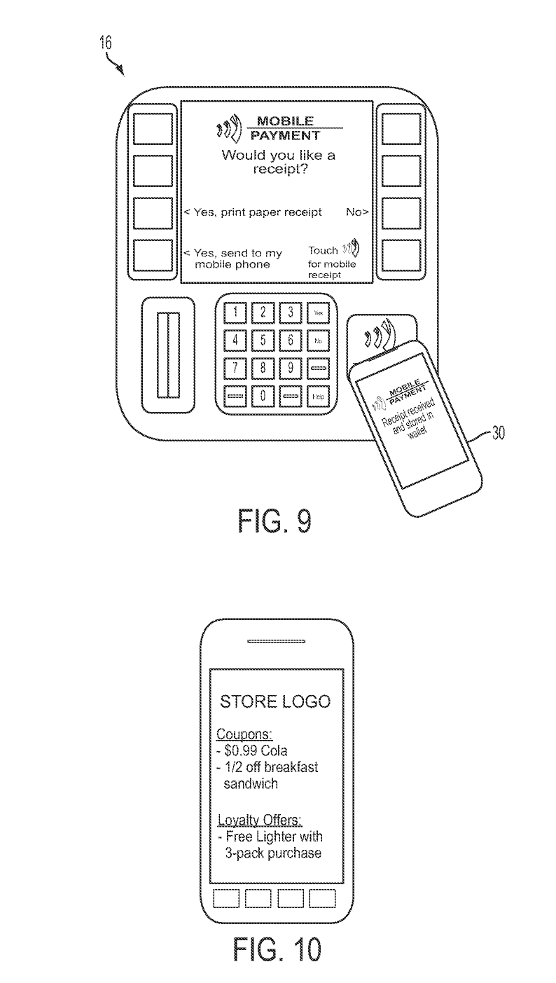

Similarly, as shown in FIGS. 8 and 9, a transaction receipt may be transferred to and stored on phone 30 via the phone network (FIG. 8) or NFC proximity transfer (FIG. 9) depending on the embodiment.

FIG. 10 illustrates a promotional message that can be sent to phone 30 during the fueling transaction that provides information on special items available in the convenience store.

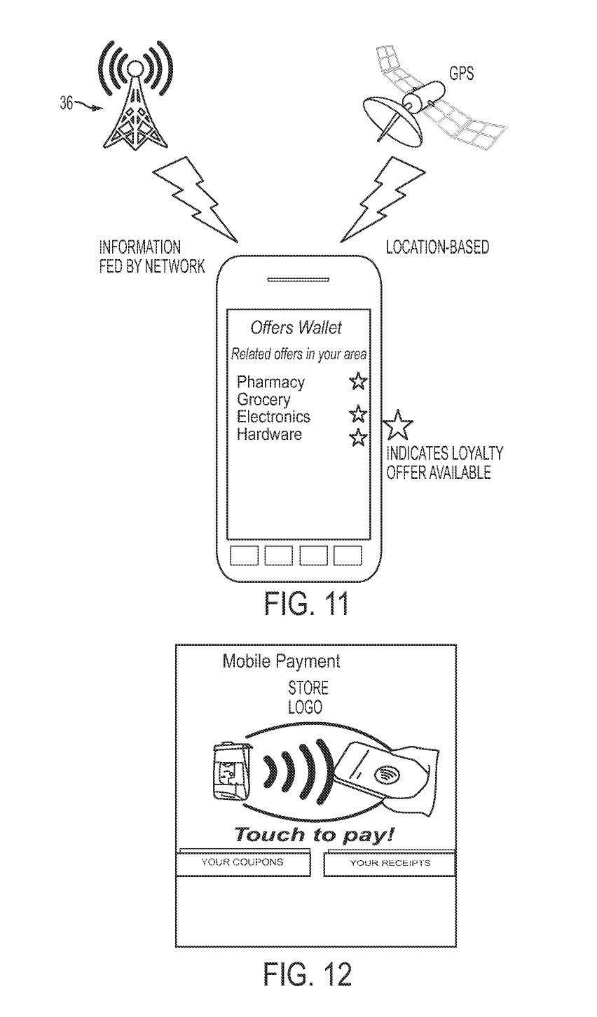

FIG. 11 illustrates another aspect of the present invention that can operate independent of an ongoing transaction. In this case, the app provides location information to central server 32 as its owner moves about from place to place. Promotional information regarding “deals” near the owner's location can then be provided to the phone and displayed. In fact, location information can be used to provide the user with local (even temporary) deals—“If you use your phone here in the next 30 minutes then get $0.15 off your gasoline.” Based on information stored in the phone, the promotions can be correlated with various loyalty programs of which the owner is a member.

FIGS. 12 through 14 show further screens than can be generated by the app installed on phone 30 at various stages of a fueling transaction. In this regard, FIG. 12 shows a “home page” that can be displayed on the phone when the customer selects the app. For example, the customer may select the app to browse stored coupons and receipts even when a current transaction is not occurring. Or, some embodiments may not start the app by push message at the beginning of a transaction, in which case the customer should start the app before bringing phone 30 into proximity with reader 28.

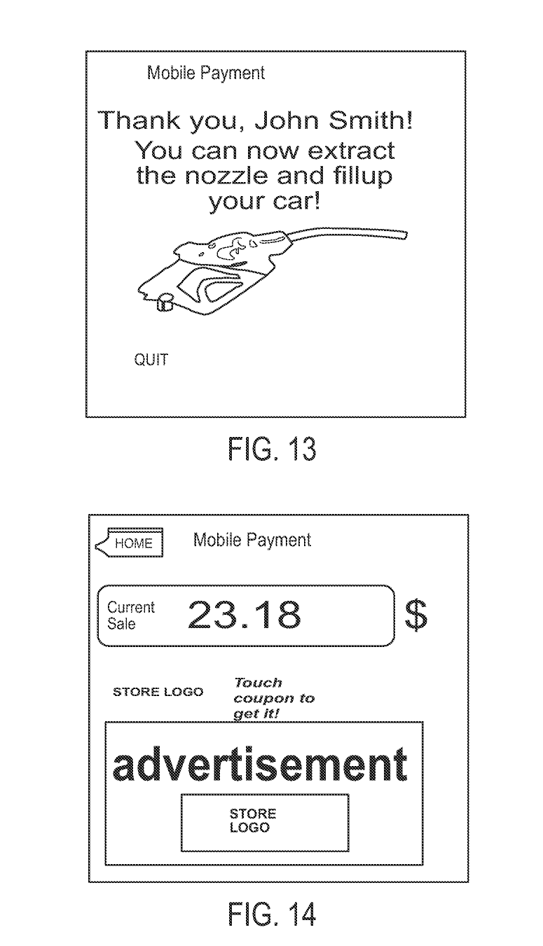

FIG. 13 shows a page that may be displayed on phone 30 indicating that a fueling transaction has been authorized. Finally, FIG. 14 illustrates a page that can be displayed during the fueling transaction to show the amount of the sale on an ongoing basis. Additional information, such as price-per-unit and grade of fuel being dispensed can also be displayed. In addition, the app can log fueling amount, transaction amount, location and time to provide a transaction history of retail fueling for the customer. Furthermore, advertisements may be displayed on the cell phone's screen along with the transaction information as the transaction progresses.

Some additional features within the scope of the present invention will now be described. One such feature provides payment confirmation where a third party is responsible for, or desires to, pay for the transaction. Assume a situation where a driver (e.g., a truck driver) works for a company which will purchase the fuel. The driver initiates a fueling transaction using a proximity indicator as described above. This proximity reading provides confirmation of the driver's location (because the location of the dispenser is known), or location information can be provided by the phone itself if the phone is GPS equipped. The system may generate a message to the responsible party asking whether the driver should be allowed to obtain the fuel. A photo of the driver or vehicle odometer could also be sent via the phone's built-in camera. (Or a bluetooth-equipped vehicle could provide odometer and other vehicle information directly to the phone for transmission to the responsible party.) Based on the information provided, the responsible party can approve or disapprove of the purchase. In fact, such a “chain of mobile payment trust” could be applied to many situations (such as parent-child) or retail environments other than fuel dispensing.

According to another embodiment, the app on the cell phone can replace much of the user interface that would otherwise be located on the fuel dispenser. Or, in emerging markets or other regions where the fuel dispenser is operated by an attendant, the attendant's cell phone (or other mobile device) can become a handheld control used to control the pump. For example, the attendant could tap the dispenser with the mobile device (equipped with a proximity indicator as described above) to authorize the pump. This causes a control interface to be pulled up on the attendant's mobile device. Additionally, the attendant could also use the mobile device to scan the customer's loyalty card (which could itself be a transponder). Also, the attendant's phone could buffer the customer data and then transfer to network for authorization via NFC. In such a situation, the attendant may get back an preauthorization code which can be used to turn on a fuel dispenser (such as via NFC).

Even if the fuel dispenser is controlled in conventional fashion in an attended market, aspects of the present invention can be used by the customer to confirm the amount of the transaction. For example, attendant misrepresentation of the amount of the charge is not uncommon. In this regard, the attendant may clear the sale/volume display and then inform the customer that the amount to be charged is in excess of the true amount. There are also cases where the attendant will not dispense fuel and then inform the customer that fueling is complete with a fraudulent amount.

According to the present invention, an app on the customer's cell phone or other mobile device may be used to monitor the fuel dispensed. (It will be appreciated that retailers may decide to make the app available for free download, or it can be sold at an “app store.”) For example, a customer can remain in their vehicle and validate the transaction while it is taking place. In particular, the customer can compare the running total on the display of the fuel dispenser with the amount shown on the cell phone's screen. After the transaction is complete, the app can be configured to initiate payment for the transaction using information stored on the mobile device. Alternatively, the app may be configured to stop the transaction at a certain prepaid amount for which payment has been made via the customer's mobile device.

In addition, it is contemplated that the app may be configured to provide an alarm for various conditions, such as no fuel dispensed, inadequate fuel dispensed, transaction stopped, fueling started, fueling stopped. If an interface to the vehicle exists (e.g., Bluetooth) and the vehicle has instrumentation that indicates amount of fuel added to the gas tank, the app can check for any difference between the amount of fuel received and what was purportedly dispensed.

To display real time transaction information, the app can communicate directly with the dispenser or with the dispenser indirectly via a site server using various wireless technologies. For example, the dispenser (or site server) and the mobile device may communicate through any suitable wireless technology, such as Bluetooth, wifi, GSM, CDMA, etc. In addition, the app may identify the dispenser in various suitable ways, such as using either a dispenser identifier located on the dispenser which is imaged by the mobile device (or possibly entered into the mobile device manually if the identifier is a simple number). Alternatively, or in addition, GPS or other location technology can be used to identify, or validate the identification of, the dispenser.

According to some embodiments, the payment app on the phone can encourage the customer to use coupons in various ways. For example, the app can check coupons stored on the phone (or a remote location) for their dates of expiration. The expired ones are automatically discarded. If a coupon is about to expire, the app can prompt the customer—“Do you want to use this coupon expiring in two days?” Or, using cell phone location, the user can be prompted if near the location of a store corresponding to a stored coupon (e.g., “You are near Starbucks and have coupon for cup of coffee.”).

Aspects of the present invention contemplate that the payment app can be adapted to allow preauthorization of a fueling transaction. This will limit the customer's time at the fuel dispenser to the actual time required to get fuel into the vehicle tank, thereby reducing the customer's wait and increasing station throughput. According to one method, such preauthorization may be accomplished as follows:
1. Assume a customer is in queue at a service station. The customer may launch the payment app in order to request preauthorization.
2. The central server evaluates the customer's location to determine closeness to a service station. If the customer is not near a service station, preauthorization will not be provided. If there are multiple stations in the immediate area, then the customer can be prompted to select one from among the group.
3. Assuming the customer's identity and payment method are suitably confirmed, the customer will receive a unique preauthorization transaction number (token). Preferably, the token will expire after a short period of time.
4. When customer gets to the dispenser, the “token” is entered into the dispenser. For example, if the phone is equipped with NFC, the token can be transmitted to the dispenser via the proximity reader. Immediate use of the dispenser is thus allowed.
5. One skilled in the art will appreciate that items other than fuel can be purchased in a similar manner.

While one or more preferred embodiments of the invention have been described above, it should be understood that any and all equivalent realizations of the present invention are included within the scope and spirit thereof. While much of the discussion above has involved fuel as the exemplary product being dispensed, one skilled in the art will recognize that aspects of the present invention are applicable to a wide variety of different goods and services. Thus, the embodiments depicted are presented by way of example only and are not intended as limitations upon the present invention. For example, many aspects of the present invention are described above in the exemplary context of a retail fueling environment. It should be understood by those of ordinary skill in this art, however, that the present invention is not limited to these embodiments because other commercial environments are contemplated and modifications can be made. Therefore, it is contemplated that any and all such embodiments are included in the present invention as may fall within the scope and spirit thereof.

What is claimed is:

1. A mobile payment system for use in a fuel dispensing environment to effect payment for a contemporaneous transaction involving purchase of fuel, said system comprising:
a payment terminal integrated into a fuel dispenser, said payment terminal having a proximity reader configured to detect an identifier associated with a wireless communication device;
a central server in operative communication with said payment terminal and said wireless communication device;
at least one database accessible by said central server, said database containing an association between said identifier and said wireless communication device; and
said central server being further operative to send transaction information to said wireless communication device.

2. A mobile payment system as set forth in claim 1, wherein said transaction information sent by said central server to said wireless communication device includes real-time fueling information.

3. A mobile payment system as set forth in claim 1, wherein said central server further sends at least one coupon to said wireless communication device.

4. A mobile payment system as set forth in claim 1, wherein said central server further sends at least one promotional message to said wireless communication device.

5. A mobile payment system as set forth in claim 1, wherein said central server further sends an electronic receipt regarding the transaction to said wireless communication device.

6. A mobile payment system as set forth in claim 1, wherein said proximity reader comprises an RFID reader.

7. A mobile payment system as set forth in claim 1, wherein said proximity reader comprises an NFC reader.

8. A mobile payment system as set forth in claim 1, wherein said central server communicates with said wireless communication device via a wireless phone network.

9. A mobile payment system as set forth in claim 1, wherein said central server receives payment instructions from said wireless communication device and uses said payment instructions to effect payment for said transaction.

10. A mobile payment system as set forth in claim 9, wherein said payment instructions received by said central server includes payment card information to be used to effect payment for the transaction.

11. A mobile payment system as set forth in claim 9, wherein, based on said payment instructions, said central server accesses payment card information stored in said at least one database to be used to effect payment for the transaction.

12. A method for effecting payment for a contemporaneous transaction involving the purchase of fuel, said method comprising steps of:
(a) receiving a proximity identifier supplied from a payment terminal integrated into a fuel dispenser, said payment terminal having a proximity reader;
(b) determining whether the proximity identifier corresponds in a database to a particular wireless communication device;
(c) sending a message to said wireless communication device to verify said transaction;
(d) receiving a verification from said wireless communication device;
(e) if the transaction is verified, controlling said fuel dispenser to allow fuel to be dispensed; and
(f) effecting payment for said transaction.

13. A method as set forth in claim 12, wherein information indicative of a particular charge account to be used for payment of the transaction is received from the wireless communication device after initiation of the transaction.

14. A method as set forth in claim 12, wherein a predetermined monetary amount for the transaction is effected before the fuel is dispensed, and the fuel dispenser is controlled to stop dispensing of fuel once the predetermined monetary amount has been reached.

15. A method as set forth in claim 12, further comprising the step of sending at least one of a coupon and a promotional message to said wireless communication device after initiation of said transaction.

16. A method as set forth in claim 12, further comprising the step of sending real-time transaction information as the fuel is dispensed such that a running total may be presented on the wireless communication device.

17. A method as set forth in claim 12, wherein the step of sending a message to said wireless communication device to verify said transaction involves sending a push message to automatically launch a software application installed on said wireless communication device.

18. A method of operating a mobile communication device comprising:
(a) receiving a push message at the wireless communication device instructing that a predetermined software application installed on said wireless communication device be initiated;
(b) in response to said push message, initiating and running said software application, said software application soliciting verification that a transaction for fuel, goods or services is requested;
(c) receiving verification from a user of the wireless communication device that the transaction is requested; and
(d) in response to receipt of said verification, wirelessly transmitting information from said mobile communication device indicating that the transaction is requested.

19. A method as set forth in claim 18, further comprising the step of receiving at least one of a coupon and a promotional message at said wireless communication device after initiation of said transaction.

20. A method as set forth in claim 19, further comprising the step of storing said coupon on said mobile communication device for later use by the user.

21. A method as set forth in claim 20, wherein said software application is further operative to remind the user about the coupon at a selected interval prior to its expiration.

22. A method as set forth in claim 21, wherein said software application is further operative to associate said coupon after being stored with the user's location and remind the user about the coupon when the user is proximate a retail location at which it can be used.

23. A method as set forth in claim 18, wherein the transaction involves the purchase of fuel and further comprising the step of receiving and displaying real-time transaction information on the mobile communication device as the fuel is dispensed.

24. A method as set forth in claim 23, further comprising the step of receiving and storing in the mobile communication device a receipt of the transaction.
